(19) United States
(12) Patent Application Publication
(10) Pub. No.: US 2006/0223444 A1
(43) Pub. Date: Oct. 5, 2006

(54) Method and system for adaptive control of reverse link interference

(76) Inventors: Jonathan H. Gross, Gilbert, AZ (US); Brian A. Hansche, Gilbert, AZ (US)

Correspondence Address: MOTOROLA, INC., 1303 EAST ALGONQUIN ROAD, IL01/3RD, SCHAUMBURG, IL, 60196, US

(21) Appl. No.: 11/095,197

(22) Filed: Mar. 31, 2005

(51) Int. Cl. H04B 17/00

(52) U.S. Cl. 455/67.13

(57) ABSTRACT

A method for controlling reverse link loading in a communication system comprises determining a reverse link load in the communication system. The communication system comprises a plurality of mobile units configured to receive a rate indicator from a base station. The rate indicator comprises a first state indicating the mobile units can increase their data transmission rate and a second state indicating that the plurality of mobile units can decrease their transmission rate. In a next step, a duty cycle of the rate indicator based on the reverse link load is set. The relationship between the reverse link loading and the duty cycle of the rate indicator is further determined adaptively based on the measured loading and link loss rate characteristics. Then, the rate indicator is sent to the plurality of mobile units using the duty cycle.

### TECHNICAL FIELD OF THE INVENTION

This invention relates to the field of wireless communications and more particularly, to a method and system for adaptive control of reverse link interference.

### BACKGROUND OF THE INVENTION

Typical wireless communication systems provide voice and data services using separate frequency carriers. For example, GSM wireless systems data services are provided using GPRS. For CDMA systems, data service is provided using the evolved 1× services especially the CDMA2000 High Rate Packet Data Air Interface Specification (EvDo).

In a wireless communication system, base stations communicate with associated mobile units over a forward link and mobile units communicate with base stations over a reverse link. In certain wireless systems, such as CDMA systems, all mobile units can transmit to the base station at the same time. The quality of the signal received at the base station depends, in part, on the noise generated by the mobile units. That is, the noise in the reverse link, also known as the reverse link load, impacts the quality of the signal received by the base station.

One way to control the amount of noise in the reverse link involves using a common control scheme. In a common control scheme, the mobile units initially start broadcasting at a minimal data transmission rate. The base station examines the reverse link load (for example, by measuring the reverse link interference level and sends a rate indicator to all of the mobile units indicating if the data transmission rates of the mobile units can either increase or decrease, depending on the reverse link load. In a typical common control scheme all mobile units receive the same rate indicator broadcasted by the base station over a common control channel.

Under the EvDo standard, the mobile units select a reverse link data transmission rate based on a set of transition probabilities and the status of a bit, known as the Reverse Activity Bit (RAB). The transition probabilities can include an increase rate transition probability that represents a probability that the mobile unit will increase its data transmission rate when it can and a decrease rate probability that represents a probability that the mobile unit will decrease its data transmission rate when it can. The RAB can be either in a set state or an unset state. If the RAB is in the set state, the mobile units can either maintain their current transmission rate or decrease their transmission rate based on the decrease rate transition probability. If the RAB is in the unset state, the mobile units will either maintain or increase their transmission rate based on their increased rate of transmission probability.

In operation, mobile units initially transmit data at a low rate. If all mobile units operate at a low data transmission rate, the reverse link load may be small but available capacity is wasted. To increase the data transmission rates, the base station can send the RAB in the unset state. The mobile units will then increase their data transmission rates based on their increase rate probability. As the mobile units increase their data transmission rates, the reverse link load increases. If reverse link load increases too much, then the possibility of interference and data loss also increases. In response to high data transmission rates overloading the reverse link, the base station can set the RAB to the set state and send the RAB to the mobile units. Network traffic will then decrease as mobile units begin to reduce their transmission rates based on the mobile units' decrease rate probability. The result is a decrease in data transmission rates and a reduction of the reverse link load. If the decrease in the transmission rate is too great, then network capacity maybe underutilized and the RAB can be placed in the unset status. The fluctuations between excessive reverse link load and network underutilization can continue to occur in present systems. What is needed is a method and system for adaptive control of reverse link interference

### BRIEF DESCRIPTION OF THE DRAWINGS

The present invention will hereinafter be described in conjunction with the following drawing figures, wherein like numerals denote like elements, and:

FIG. 1 is a block diagram of an exemplary system of the present invention;

FIG. 2 is a graph illustrating exemplary operating characteristics for the transmission data rate;

FIG. 3 is a flowchart illustrating an exemplary embodiment of the present invention;

FIG. 4 is a flowchart illustrating another embodiment of the present invention;

FIG. 5 is a flowchart illustrating yet another embodiment of the present invention; and

FIG. 6 is a block diagram of an exemplary system for use in the present invention.

### DETAILED DESCRIPTIONS OF THE DRAWINGS

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

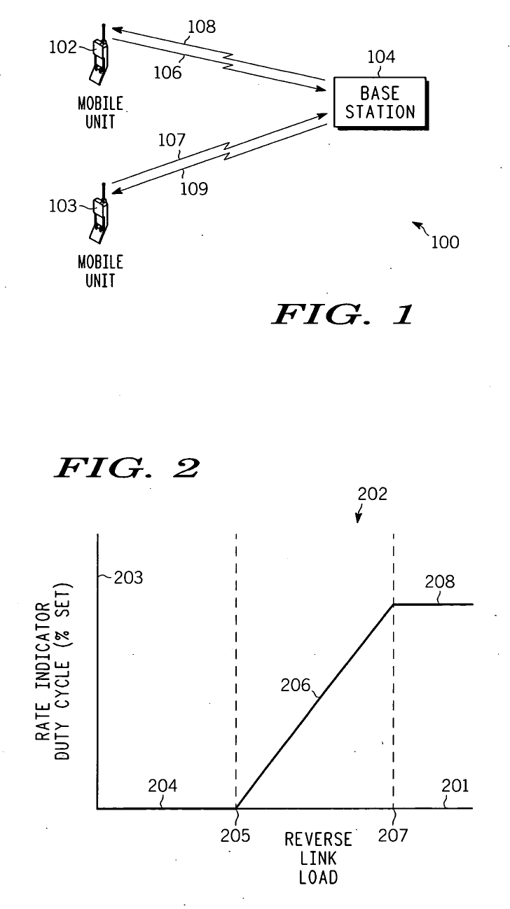

FIG. 1 is a block diagram of an exemplary communication system 100. Communication system 100 includes one or more mobile units 102, 103 communicatively coupled to one or more base stations 104. Mobile unit 102 communicates wirelessly to base station 104 over a reverse link 106 and base station 104 communicates with mobile unit 102 over a forward link 108. Mobile unit 103 communicates wirelessly to base station 104 over a reverse link 107 and base station 104 communicates with mobile unit 103 over a forward link 109. In one embodiment, mobile units 102, 103 can be mobile phones; however, mobile units 102, 103 can be any device capable of wirelessly communicating with the base station 104 (e.g., a computer, a personal digital assistant (PDA) and the like). Mobile units 102, 103 also do not have to be capable of being moved, but can be a fixed device communicating with the base station 104.

Base station 104 receives voice and/or data from mobile units 102, 103 and distributes the voice and/or data to the remainder of a communication network (not pictured), such as a mobile telephone switching office. In one embodiment, base station 104 is a radio base station that is part of a radio access network. Base station 104, in a typical embodiment, monitors network traffic and controls the mobile units 102, 103 to help control network traffic.

In an embodiment of the present invention, the data rates of mobile units 102, 103 are allowed to change based on varying the duty cycle of a rate indicator sent from the base station 104 to the mobile units 102, 103. The rate indicator can be any designator, message, flag or other indicator, such as the reverse activity bit (RAB) in CDMA systems, sent from the base station 104 over the forward links 108, 109 to the mobile units 102, 103 that signal the mobile units 102, 103 to attempt to either increase or decrease the mobile unit's data transmission rate. In an exemplary embodiment, the rate indicator can be in either an unset status, which allows the data transmission rate of mobile units 102, 103 to increase, or in a set status, which allows the data transmission rates of the mobile units 102, 103 to decrease. The duty cycle of the rate indicator is the ratio of the time the rate indicator is in a set state to the total time the rate indicator is set Typically, the duty cycle is expressed as a percentage. In a CDMA communication system, the base station 104 sends a signal to either set or clear the RAB of the mobile units 102, 103.

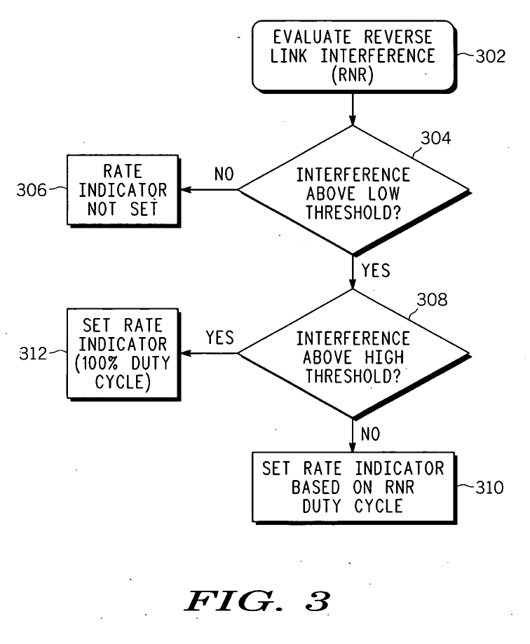

FIG. 2 is a graph 202 of reverse link load versus the rate indicator's duty cycle in an exemplary embodiment of the present invention. The vertical axis 203 represents the rate indicator duty cycle, and the horizontal axis 201 represents the reverse link load. Graph 202 is divided into three different operating sections A first section 204 is characterized by a relatively low reverse link load and extends to a first threshold 205. Second section 206 is characterized by a moderate amount of reverse link load and extends from the first threshold 205 to a second threshold 207. A third section 208 is characterized by a high amount of reverse link load and extends past the second threshold 207.

When the base station 104 is operating in the first section 204, the reverse link load is relatively low. Because the reverse link load is relatively low, the data transmission rates of the mobile units 102, 103 can be increased rapidly to best utilize system resources. To achieve the rapid increase in the data transmission rate, when the reverse link load is below the first threshold 205, the rate indicator can always be in the unset state. This corresponds to a duty cycle of zero percent. As discussed previously, when the rate indicator is in the unset state the mobile units 102, 103 will either maintain or increase their data transmission rates based on the increase rate probability of the mobile units 102, 103. While the duty cycle in first section 204 is shown to be zero percent, the duty cycle could also increase in the first section 204. To allow a rapid increase in data transmission rates lower duty cycles should be selected.

If the base station 104 is operating in the second section 206, the amount of network interference is moderate. Thus, in one embodiment, the data transmissions rates of the mobile units 102, 103 are allowed to increase, but the data transmission rates increase at a slower rate than in the first section 204. The slower increase in the data transmission rate is achieved by varying the rate indicator's duty cycle based on the reverse link load. For example, when the reverse load link is still fairly low, the duty cycle of the rate indicator can also be low, e.g., approximately 10%. As the reverse link load increases, the duty cycle of the rate indicator also increases. When the reverse link load reaches the second threshold 207, the rate indicators duty cycle has reached 100%.

While the change from 0% duty cycle to 100% duty cycle shown in FIG. 2 is illustrated as a linear function, any increasing function can be used. The relationship between the reverse link load and the duty cycle of the rate indicator can be stored in a lookup table at the base station 104. Alternatively, a mathematical function, stored at the base station 104, can be used to determine a duty cycle of the rate indicator given a reverse link load.

If the base station 104 is operating in the third section 208, the reverse link load level is high enough to exceed the second threshold 207. When operating in the third section 208, the rate indicator duty cycle is set to 100%. Thus, the rate indicator is always set, causing the mobile units 102 to decrease their data transmission rate, which will result in the operation of the mobile units 102, 103 returning to the second section 206. The shape of graph 202, which illustrates an exemplary embodiment, can vary as the relationship between the reverse link load and the duty cycle of the rate indicator can have many different shapes.

The first threshold 205 can be chosen such that when the base station 104 is operating in the first section 204, the mobile units 102, 103 can experience a rapid increase in data transmission rates when the reverse link load is low. This enhances system efficiency. Past the first threshold 205, the reverse link load has increased to the point that a more controlled increase in data transmission rate is needed. The second threshold 207 can be set at a noise level above which communication interference becomes excessive. Thus, second threshold 207, in one embodiment, is set at a reverse link load above which the system should not operate. Different methods of adjusting the first threshold 205 and second threshold 207 are discussed in detail below.

FIG. 3 is a flowchart of an exemplary method for controlling reverse link interference. In a first step, step 302, the reverse link load is evaluated. The reverse link load can be used as a measure of network traffic and can be calculated in several ways including measuring the interference level in the reverse link (RNR) or the signal to noise ratio in the reverse link.

Next, in step 304, it is determined if the reverse link load is below the first threshold 205. If it is, then in step 306, the rate indicator is in the unset state, which is equivalent to setting the duty cycle of the rate indicator to zero. When the rate indicator is in the unset state the mobile units 102, 103 can increase their data transmission rate.

If the reverse link load is above the first threshold 205, then, in step 308, it is determined if the reverse link load is above a second threshold 207. If the reverse load link is not above the second threshold 207, then, in step 310, the duty cycle of the rate indicator can be varied as a function of the reverse link load. When the rate indicator is in the set status, the mobile units 102, 103 either maintain or decrease their data transmission rates based the mobile units' 102, 103 decrease rate probability. As the duty cycle of the rate indicator increases (e.g., percent of time that the rate indicator is in the set state increase), the speed that the data transmission rate increases will decrease. Therefore, in second section 206, the data rate of mobile units 102, 103 will increase but at a slower rate than the increase in the first section 204.

If the reverse link load is above the second threshold 207, then, in step 312, the duty cycle can be set to one-hundred percent. This is equivalent to always setting the rate indicator to the set status. In the third section 208, mobile units 102, 103 will either maintain their current data transmission rate or will decrease their data transmission rate, the choice determined by the transmission probabilities. Thus, this region is characterized by an overall decrease in the data transmission rates. Note that a decrease in data transmission results in a decrease in the reverse link load. When the reverse link load decreases past the second threshold 207, the duty cycle of the rate indicator will drop below one hundred percent and the data transmission rates of the mobile units 102, 103 will be allowed to increase as seen in the second section 206.

The present invention, as shown in the exemplary FIGS. 2-3, allows for a rapid ramp-up in data transmission rates under low reverse link load conditions and provides for a stable system under higher reverse link loads. However, the placement of the first threshold 205 and the second threshold 207 may need to be adjusted for optimization purposes. For example, if the link loss rate, as measured in one embodiment by the loss of data packets, is above a higher desired threshold, then excessive data loss can occur and adjustments to first threshold 205 and second threshold 207 can be made.

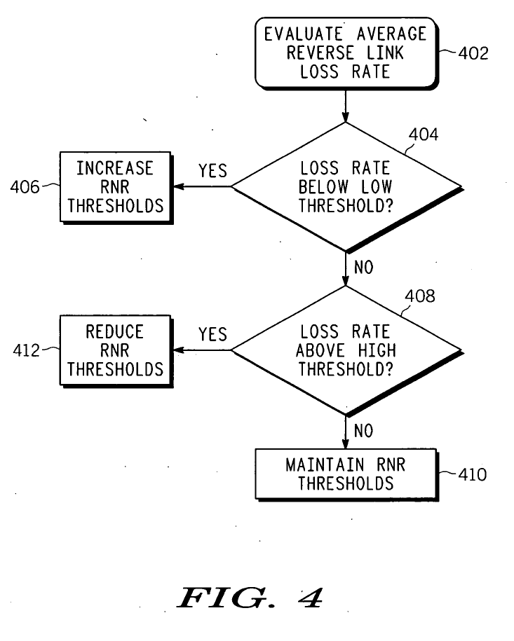

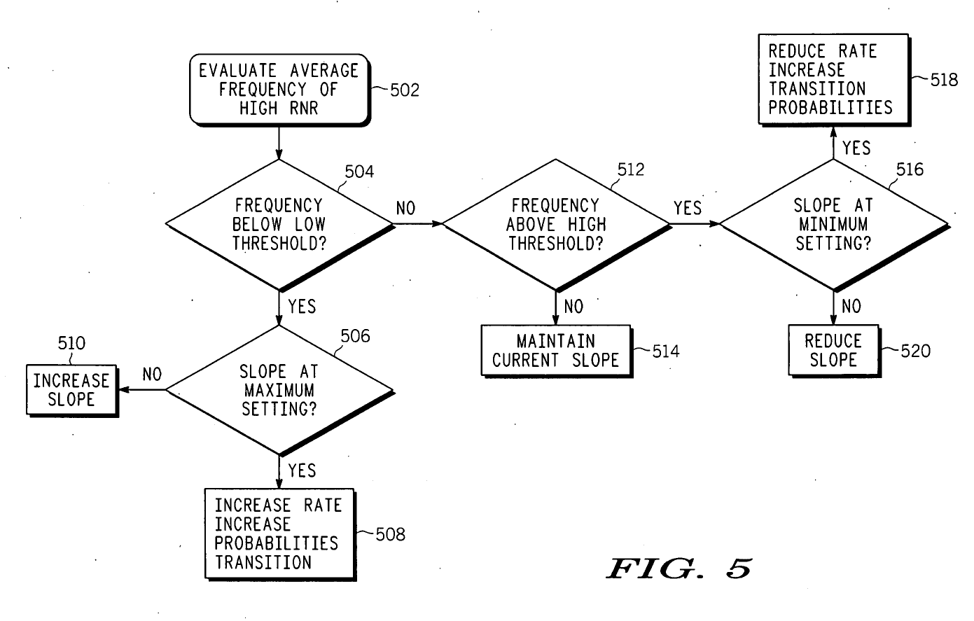

FIG. 4 is a flowchart of an alternate embodiment of the present invention that adjusts the relationship between the reverse link load and the duty cycle of the rate indicator when the reverse link loss is larger or smaller than desired. In a first step, step 402, the reverse link loss rate is evaluated. In one embodiment, the reverse link loss can be averaged over a period of time or averaged using an exponential averaging scheme. The reverse link loss rate evaluation can be done in many different ways including the examination of physical layer and/or RLP layer statistics.

In step 404, it is determined if the reverse link loss rate is below a desired low loss rate threshold. If the loss rate is below the low loss rate threshold, the mobile units 102, 103 are operating with inefficient data transmission rates. Thus, the mobile units 102, 103 could operate at a higher data transmission rate and have a higher reverse link load level. Therefore, in step 406, the first threshold 205 and/or the second threshold 207 can be set at a higher reverse link load Thus, first section 204 can terminate at a larger reverse link load. Increasing the reverse link load for the first threshold 205 permits a rapid increase in data transmission rates for a longer time. Additionally, since the mobile units are operating below a low loss rate threshold, the second section 206 can also terminate at a larger reverse link load.

If the loss rate is not below a low loss rate threshold, it is determined if the loss rate exceeds a high loss rate threshold in step 408. If not, then in step 410 the current first threshold 205 and second threshold 207 are maintained.

If the loss rate exceeds the desired loss rate threshold, then in step 412 the first threshold 205 and/or the second threshold 207 are reduced. If the loss rate is above a high target level, the base stations 104 needs to operate at a lower reverse load levels to avoid excessive data loss. Thus, the first section 204 can end at a lower reverse link load by setting the first threshold 205 to a lower reverse link load value. This decreases the mobile units 102, 103 ability to increase data transmission rates rapidly. Also, the second threshold 207 can be set at a lower reverse link load. By setting the second threshold 207 at a lower link load, the decrease in data transmission rates that occur in the third section 208 starts at a lower reverse link load. In one embodiment, both the first threshold 205 and the second threshold 207 can be set to a lower reverse link load.

FIG. 5 is a flowchart illustrating an alternate embodiment of the present invention that adjusts the relationship between the reverse link load and the duty cycle of the rate indicator for use when the average frequency or rate of high interference falls below a low threshold or the average frequency or rate of high interference is above a high threshold. In a first step, step 502, the average frequency of operation at a high interference level is determined. The average frequency of operation at a high level can be determined, in one embodiment, by determining how often the overall system operates above the second threshold 207. High interference level can be determined by communication system 100, preferably by base station 104

Next, in step 504, the base station 104 determines if the average frequency determined in step 502 falls below a low frequency of high interference threshold. Operating below a low frequency of high interference threshold indicates that the system is not operating efficiently. In step 506, if the frequency of high interference is below a low threshold, the base station 104 determines if the slope of the graph 202 in the second section 206 is at a maximum setting. The maximum setting is a predetermined maximum slope of the second section 206. If the slope is at the maximum setting, the transition probabilities are increased in step 508. Increasing the transition probabilities involves either changing the rate increase transition probability, changing the rate decrease transition probability or changing both to insure that the probability of a rate increase is greater than that of a decrease. By increasing the transition probabilities, the mobile units 102, 103 can increase their data transmission rates more rapidly.

If, in step 506, the base station 104 determines that the slope in the second section 206 is not at the maximum setting, then, in step 510, the slope can be increased. The slope in the second section 206 can be increased by decreasing the interval between the first threshold 205 and the second threshold 207. By decreasing this interval, the duty cycle increases over a shorter interval, which means the slope has increased. The increase of the slope can be accomplished by setting the first threshold 205 at a larger reverse link load. This is equivalent to shifting the first threshold 205 to the right. This allows for a rapid ramp up of data transmission rates for a longer period of time in the first section 204 and helps to prevent the average frequency of peak operation from dropping below a low threshold. This allows for slowing down the increase in the data transmission rate at a lower reverse link load. In another embodiment, the second threshold 207 can be set at a smaller reverse link load (shifting the second threshold 207 to the left). In yet another embodiment, the second threshold 207 can be shifted to the left and the first threshold 207 can be shifted to the right. While the slope of the second section 206 of FIG. 2 relates to the slope of a linear region, the adjustments to any increasing function in the second section 206 can be made in a similar fashion.

If, in step 504, the base station 104 determines that the frequency of high interference is not below a low threshold, in step 512 the base station 104 determines if the frequency of high interference is above a high threshold. If not, in step 514 the current slope and, therefore, the first and second thresholds are maintained.

If, in step 512, the frequency is above a high threshold, the base station 104 determines in step 516 if the slope of the graph is at a minimum setting. The minimum setting is a predetermined minimum slope of second section 206. If the slope is at a minimum setting, the transition probabilities are decreased. Decreasing the transition probabilities involves either changing the rate increase transition probabilities, changing the rate decrease transition probability or changing both to insure that the probability of a rate decrease is greater than that of an increase. By decreasing the transition probabilities, the mobile units 102, 103 can decrease their data transmission rates more rapidly when the rate indicator is in the set status.

If, in step 516, the base station 104 determines that the slope of the graph 202 in the second section 206 is not a minimum setting, then, in step 520, the slope of the graph can be decreased. This can be accomplished by setting the first threshold 205 at a smaller reverse link load. This is equivalent to shifting the first threshold 205 to the left. This allows for a rapid ramp up of data transmission rates for a shorter period of time. Also, the second section 206 is reached at a lower reverse link load. This allows for slowing down the increase in the data transmission rate at a lower reverse link load. While shifting the second threshold 207 to the right would also decrease the slope of the second section 206, this would require increasing the maximum reverse link loading that the system experiences. If the system is already experiencing excessive data loss at the current second threshold 207, allowing the mobile units 102, 103 to operate at an even higher reverse link load would most likely result in more data loss.

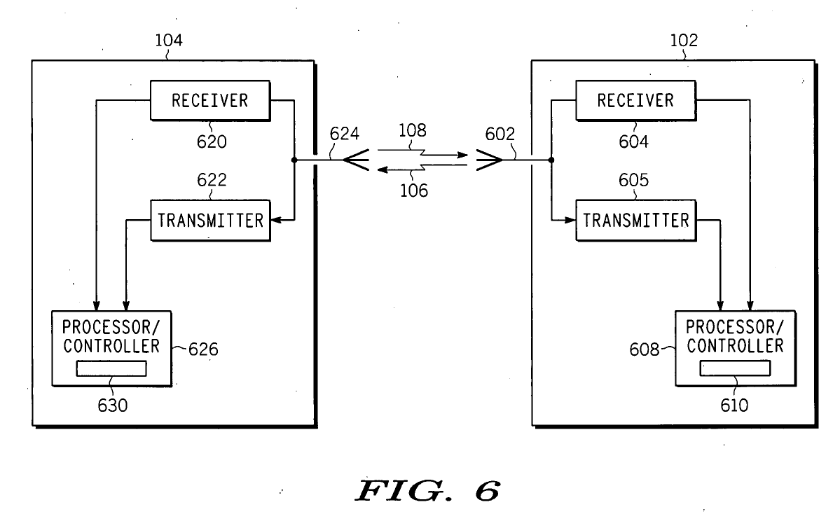

FIG. 6 is a block diagram of an exemplary mobile unit 102 and base station 104 for use in the present invention. Base station 104 comprises, in an exemplary embodiment, a base station receiver 620 and a base station transmitter 622, both of which are coupled to a base station antenna 624. A base station processor/controller 626 is coupled to both the base station receiver 620 and the base station transmitter 622.

Base station receiver 620 converts reverse link 106 signals received by base station antenna 624 to a digital stream that can be passed on to the rest of the network. The base station processor/controller 626 can execute processes to support the execution outlined in FIGS. 3-5. For example, in one embodiment, base station processor/controller 626 includes a load level process 630 that can determine the reverse link load from the signals received at base station receiver 620. Based on the reverse link load, the load level process 630 can also determine the duty cycle of the rate indicator to set based on the reverse link load. Also, the load level process 630 can determine if the rate increase probability or rate decrease probability should be changed. The status of the rate indicator as well as any adjustments to the rate increase or decrease transition probability can be sent to the mobile unit 102 over the forward link 108 using base station transmitter 622 and base station antenna 624.

Mobile unit 102, comprises, in an exemplary embodiment, a mobile unit receiver 604 and mobile unit transmitter 605 both of which are coupled to a mobile unit antenna 602. A mobile unit processor/controller 608 is coupled to both the mobile unit receiver 604 and the mobile unit transmitter 605.

The signal from the base station receiver 620 is received by the one or more mobile units 102. Specifically, signals from the forward link 108 from the base station 104 are received mobile unit receiver 604 from mobile unit antenna 602. The mobile unit processor/controller 608 receives data from the mobile unit receiver 604. In one embodiment, mobile unit processor/controller 608 can extract the duty cycle of the rate indicator from the received data. Also, a change to the increase rate transition probability and decrease rate transition probability can also be extracted. In one embodiment, mobile unit processor/controller 608 can execute a rate setting process 610. Rate setting process 610, based on the status of the rate indicator can generate a random number that can be compared to the increase rate transition probability or decrease rate transition probability to determine if the data transmission rate should increase or stay the same.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed:

1. A method for controlling reverse link loading in a communication system comprising a plurality of mobile units configured to receive a rate indicator from a base station, the rate indicator capable of assuming a first state indicating the mobile units can increase their data transmission rate and a second state indicating that the plurality of mobile units can decrease their transmission rate, the method comprising:
determining a reverse link load in the communication system;
setting a duty cycle of the rate indicator based on the reverse link load; and
sending the rate indicator to the plurality of mobile units using the duty cycle.

2. The method of claim 1 further comprising:
determining a low noise threshold;
determining a high noise threshold; and
varying the duty cycle of the rate indicator when the reverse link load is between the low noise threshold and the high noise threshold.

3. The method of claim 2 further comprising setting the duty cycle of the rate indicator such that the rate indicator is in the first state until the reverse link load reaches the low noise threshold.

4. The method of claim 2 further comprises setting the duty cycle of the rate indicator such that the second state of the rate indicator is sent to the mobile units when the reverse link load exceeds the high noise threshold.

5. The method of claim 3 wherein the step of varying the duty cycle further comprises varying the duty cycle of the rate indicator when the reverse link load is greater than the low noise threshold and less than the high noise threshold.

6. The method of claim 2 further comprising the steps of:
measuring an average reverse link loss rate;
determining if the average reverse link loss rate is below a low loss rate threshold; and
if the average reverse link loss rate is below the low loss rate threshold, increasing the low noise threshold, increasing the high noise threshold or a combination of increasing the low noise threshold and increasing the high noise threshold.

7. The method of claim 6 further comprising the steps of:
if the average reverse link loss rate exceeds the low loss rate threshold; determining if the average reverse link loss rate exceeds a high loss rate threshold; and
if the average reverse link loss rate exceeds the high loss rate threshold, decreasing the low noise threshold, decreasing the high noise threshold or a combination of decreasing the low noise threshold and decreasing the high noise threshold.

8. The method of claim 2 further comprising:
evaluating an average frequency of high interference;
determining if the average frequency of high interference is below a low interference threshold;
if the average frequency of high interference is below the low interference threshold, determining if the rate of increase of the duty cycle of the rate indicator between the low noise threshold and the second noise threshold is at a maximum value;
if the rate of increase of the duty cycle of the rate indicator between the low noise threshold and the high noise threshold is at the maximum value, modifying a rate transition probability for each of the plurality of mobile units to increase the transition probability; and
if the rate of increase of the duty cycle of the rate indicator between the low noise threshold and the high noise threshold is not at a maximum value, decreasing the interval between the low noise threshold and the high noise threshold.

9. The method of claim 8 further comprising:
determining if the average frequency of high interference is above a high interference threshold;
if the average frequency of high interference is above the high interference threshold, determining if the rate of increase of the duty cycle of the rate indicator between the low noise threshold and the high noise threshold is at a minimum value;
if the rate of increase of the duty cycle of the rate indicator between the low noise threshold and the high noise threshold is at the minimum value, modifying a rate transition probability for each of the plurality of mobile units to decrease the transition probability; and
if the rate of increase of the duty cycle of the rate indicator between the low noise threshold and the high noise threshold is not at a minimum value, decreasing the low noise threshold and maintaining the high noise threshold.

10. A method for controlling reverse link loading in a communication system comprising a plurality of mobile units configured to receive a rate indicator from a base station, the rate indicator comprising a first state indicating the mobile units can increase their data transmission rate and a second state indicating the mobile units can decrease their transmission rate, the method comprising:
evaluating a reverse link load; and
setting a duty cycle of the rate indicator based on the reverse link load, the duty cycle set at:
zero percent when the reverse link load is less than a first threshold,
between zero and one-hundred percent when the reverse link load is between the first threshold and a second threshold; and
one hundred percent when the reverse link load exceeds the second threshold.

11. The method of claim 10 further comprising the steps of:
measuring an average reverse link loss rate;
determining if the average reverse link loss rate is below a low loss rate threshold; and
if the average loss rate is below the low loss rate threshold, increasing the first threshold, increasing the second threshold or a combination of increasing the first threshold and increasing the second threshold.

12. The method of claim 11 further comprising the steps of:
if the average reverse link loss rate exceeds the low loss rate threshold; determining if the average reverse link loss rate exceeds a high loss rate threshold; and
if the average reverse link loss rate exceeds the high loss rate threshold, decreasing the first threshold, decreasing the second threshold and/or a combination of decreasing the first threshold and decreasing the second threshold.

13. The method of claim 10 further comprising:
evaluating an average frequency of high interference;
determining if the average frequency of high interference is below a high interference threshold;
if the average frequency of high interference is below the high interference threshold, determining if the rate of increase of the duty cycle of the rate indicator between the first threshold and the second threshold is at a maximum value;
modifying a rate transition probability for each of the plurality of mobile units to increase the transition probability, if the rate of increase of the duty cycle of the rate indicator between the first threshold and the second threshold is at the maximum value; and
decreasing the interval between the first threshold and the second threshold if the rate of increase of the duty cycle of the rate indicator between the first threshold and the second threshold is not at a maximum value.

14. The method of claim 10 further comprising:
determining if the average frequency of high interference is above a high interference threshold;
if the average frequency of high interference is above the high interference threshold, determining if the rate of increase of the duty cycle of the rate indicator between the first threshold and the second threshold is at a minimum value;
modifying a rate transition probability for each of the plurality of mobile units to decrease the transition probability if the rate of increase of the duty cycle of the rate indicator between the first threshold and the second threshold is at the minimum value; and
decreasing the first threshold and maintaining the second threshold if the rate of increase of the duty cycle of the rate indicator between the first threshold and the second threshold is not at a minimum value.

15. A base station for controlling reverse link load, the base station configured to send a rate indicator to a plurality of mobile units, the rate indicator comprising a first status indicator that indicates the mobile units can increase their data transmission rate and a second status that indicates the mobile units can decrease their data transmission rate, the base station comprising:
a receiver unit to receive a reverse link signal; and
a processor coupled to the receiver, the processor configured to determine the loading in the reverse link signal, the processor further configured to set a duty cycle for the rate indicator based on the reverse link load.

16. The base station of claim 15 wherein the processor is further configured to:
determine a low noise threshold;
determine a high noise threshold; and
vary the duty cycle of the rate indicator when the reverse link load is between the low noise threshold and the high noise threshold.

17. The base station of claim 16 wherein the processor is further configured to set the duty cycle of the rate indicator to the first state until the reverse link load reaches the low noise threshold.

18. The base station of claim 16 wherein the processor is further configured to set the duty cycle of the rate indicator to the second state when the reverse link load exceeds the high noise threshold.

19. The base station of claim 17 wherein the step of varying the duty cycle further comprises varying the duty cycle of the rate indicator when the reverse link load is greater than the low noise threshold and less than the high noise threshold.

20. The base station of claim 16 wherein the processor is further configured to determine the duty cycle of the rate indicator using an increasing function of the reverse link load.
